(19) United States
(12) Patent Application Publication
(10) Pub. No.: US 2005/0253709 A1
(43) Pub. Date: Nov. 17, 2005

(54) Hazardous condition detector with integral wireless connectivity infrastructure device

(76) Inventor: Paul J. Baker, Dublin, OH (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/129,528

(22) Filed: May 13, 2005

Related U.S. Application Data
(60) Provisional application No. 60/571,147, filed on May 14, 2004.

(51) Int. Cl. G08B 1/08

(52) U.S. Cl. 340/539.26

(57) ABSTRACT

A hazardous condition detector device that includes wireless communication capability for expanding the connectivity range of a wireless network. The hazardous condition detector includes a unitary housing that includes both a wireless communication device and a hazardous condition detection circuit. The combined hazardous condition detector and wireless infrastructure device is mounted within a building in an optimal location to enhance the interconnectivity range of the wireless network. The hazardous condition detection circuit is operable to sense the presence of a hazardous condition and generate an alarm signal. The hazardous condition detector forms part of a combined hazardous condition detection and wireless computer network infrastructure that both enhances the wireless connectivity with a building and satisfies building code-required hazardous condition detection parameters.

### CROSS REFERENCE TO RELATED APPLICATION

The present application is based on and claims priority to U.S. provisional patent application Ser. No. 60/571,147, filed on May 14, 2004.

### BACKGROUND OF THE INVENTION

The present invention generally relates to monitoring detectors used in buildings. More specifically, the present invention relates to a hazardous condition detector having wireless communication capability for use in extending the connectivity range of a wireless network.

Home and/or business wireless networks are currently hampered by the lack of a supporting infrastructure within a building or home to enable complete connectivity throughout the building. Wireless communication systems, such as but not limited to WI-FI (IEEE 802.11 and all variants), Zigbee or IPV6 (IEEE 802.15.4) and Bluetooth (IEEE 802.15.1) promise the ability to wirelessly connect peripheral device in distant parts of the building. Throughout the present application, the term wireless systems will be used to refer to the various types of wireless communication systems identified above, as well as equivalent systems currently available and those that will be available in the future. Although wireless system function well in relatively small buildings, these wireless systems are frequently limited by poor range or the inability to operate throughout an entire larger building. Conversely, some systems may experience a security issue as the network extends to nearby houses, buildings or areas where unauthorized access may occur. In addition, by having multiple points of wireless access in the dwelling, the needed range of a single device is reduced. The reduction in required range for each device will allow for cheaper electronics (reduced sensitivity, less output power), shorter distance to intrude on other neighboring wireless networks causing interference, and the reduction in the likelihood of being within range of an unauthorized user.

One method of addressing the limited range of wireless communication systems is to place routers and/or repeaters throughout the building to enhance the range of accessibility. Although the use of commercially available routers and/or repeaters will partially solve the problem, a drawback exists in the placement and the physical location of the routers and/or repeaters at optimal locations throughout the building.

In a wireless network system set up within a building, such as an individual residence, a homeowner may install a powerful repeater to ensure wireless connectivity throughout the home. However, the use of a powerful repeater has the drawback of expanding the wireless network range to encompass neighbors or even passing cars on the street. This enhanced wireless range invites security breaches and the use of multiple repeaters, depending on the technology used, restricts the wireless access speed and restricts available bandwidth.

Although the use of a wireless repeater extends the connectivity range of a wireless network, the wireless repeater must be provided with a source of electrical power within the building. Thus, the wireless repeater is typically positioned near an electrical outlet within the building and thus may be visible within the room in which it is positioned. Since it is desirable to position the wireless repeater within range of the main wireless router for the network, the repeater may need to be positioned within a room of the building in which the repeater is visually distracting. Further, since the walls, ceiling and floor of each room within the building effect the connectivity range for the repeater, it is desirable to position the repeater as close to the center of the room as possible to enhance the transmission range. If the optimal location for the wireless repeater is in an open or nicely decorated room, the wireless repeater may have to be repositioned so as to not distract from the visual appearance of the room. This problem is particularly acute if the wireless technology uses a line-of-sight limited communication, such as infrared communications, where room positioning is most critical.

Therefore, a need exists for a wireless connectivity infrastructure device that enhances the connectivity range of a wireless network while providing the ability to place the device in an optimal location within a building.

### SUMMARY OF THE INVENTION

The present invention provides a combination detector, such as a hazardous condition or security detector, that includes integrated wireless communication capability for enhancing and extending the connectivity range of a wireless network within a building. The combination detector includes a housing preferably mounted to the ceiling or a wall at a location above eye level within a room of the building. The housing for the combination detector is of a size and configuration such that it can be used with a standard mounting arrangement for standard detectors not including wireless communication capability.

In a preferred embodiment of the invention, the combination detector is a hazardous condition detector that includes a hazardous condition detection circuit that is contained within the housing. The hazardous condition detection circuit functions to detect a hazardous condition, such as the presence of smoke or carbon monoxide, and generates an alarm signal upon detection of the hazardous condition. Preferably, the hazardous condition detection circuit is coupled to the existing hazard detector power/communication infrastructure within the building. Typically, the hazard detector infrastructure within the building includes both a main power line and a communication line. The communication line allows the hazardous condition detection circuit to conductively communicate with other hazardous condition detectors, while the detectors receive power from the main power line.

The hazardous condition detector further includes a wireless communication device, such as a wireless repeater, contained within the unitary housing. Thus, the unitary housing includes both the wireless communication device and the hazardous condition detection circuit. The wireless communication device is operable to receive and transmit wireless communication signals within the building. Preferably, the wireless communication device is a wireless repeater that receives network communication signals from a wireless router and relays the signals to peripheral devices, such as desktop or laptop computers located within the building. The wireless repeater also receives network communication signals from the peripheral devices and relays such signals back to the wireless router. It is contemplated that the wireless communication device contained within the housing could be a wireless router such that the combination hazardous condition detector would provide the direct access point for network communication.

The wireless communication device is contained within the housing and receives a source of electrical power from the hazard detector infrastructure already contained within the building. Thus, no additional wiring is required to utilize the hazardous condition detector including the wireless communication device. The supply of electrical power allows the wireless communication device to transmit and receive wireless network communications signals without power consumption drawbacks.

The combination hazardous condition detector includes means for physically mounting the hazardous condition detector to existing hazardous condition detector mounting brackets. Further, the combination hazardous condition detector includes a unitary housing that includes both the hazardous condition detection circuit and the wireless communication device, which may be a wireless repeater in a preferred embodiment of the invention.

### BRIEF DESCRIPTION OF THE DRAWINGS

FIG. 1 is a schematic illustration of a building including a wireless network and utilizing the combination detector including wireless communication capability of the present invention;

FIG. 2 is a schematic illustration of the interconnection between the hazardous condition detector including wireless communication capability and other hazardous condition detectors within a building;

FIG. 3 is a schematic illustration showing the receipt of the unitary housing including the wireless communication device and hazardous condition detection circuit within a conventional hazardous condition detector mounting bracket; and

FIG. 4 is a schematic illustration of a building including a wireless network and utilizing the combination detector including wireless communication capability.

### DETAILED DESCRIPTION OF THE PREFERRED EMBODIMENT

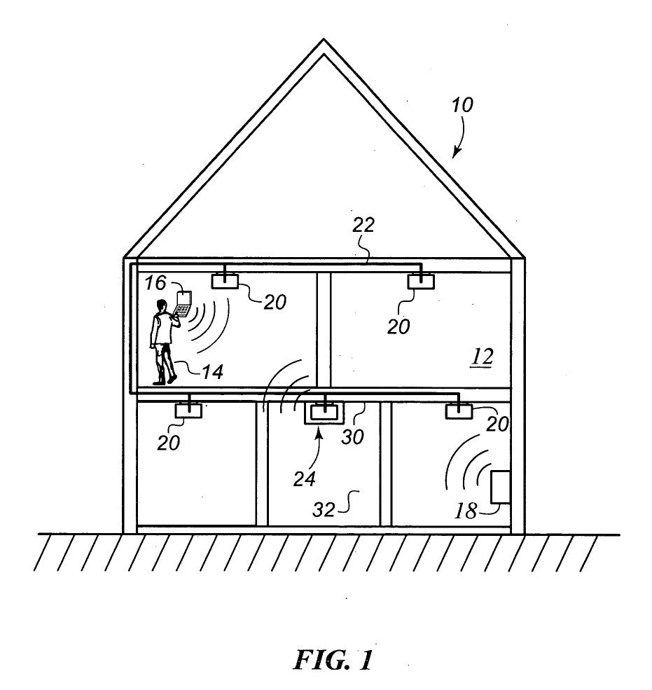

Referring first to FIG. 1, thereshown is a building 10 that includes both a wireless network and a hazard detector infrastructure. The building 10 includes multiple rooms 12 on two separate floors. The building 10 includes a wireless network that allows a user 14 to wirelessly access the network from any room 12 within the building. In the embodiment shown in FIG. 1, the user 14 is shown with a peripheral device, such as a laptop computer 16, that includes a wireless communication device that allows the user 14 to remain connected to the wireless local area network (LAN) throughout the building. Typically, the building 10 includes a wireless router 18 that is positioned within one of the rooms of the building 10 and acts as the main access point for the wireless LAN.

In a typical application, the wireless router 18 provides an access portal to the internet, a local intranet, or a main server located within the building 10. The wireless router 18 typically communicates utilizing IEEE 802.11 (commonly called WI-FI with variants with alphabetic suffixes), but there are multiple variations in standards. In most applications, the wireless router 18 has a connectivity range that depends upon the physical structure of the building and the location of the wireless router 18 within the building. In many buildings, the range of the wireless router 18 is insufficient to provide connectivity throughout every room within the building.

The building 10 shown in FIG. 1 also includes a detector network. In the embodiment of the invention shown, the detector network includes conventional hazard detectors 20 positioned within most, if not all, of the rooms 12 within the building 10. Although hazard detectors 20 are shown, the present invention could also be used with a security system including multiple motion or heat detectors, each coupled to a main control panel.

The hazard detectors 20 are each connected to an infrastructure, generally shown by line 22. Although the line 22 is shown as a single wire in FIG. 1, it should be understood that the connecting line 22 includes at least a main power supply line and a communication line that allows each of the hazard detectors 20 to communicate with each other. The method of interconnecting the individual hazard detectors in an alarm system is described in detail U.S. Pat. No. 6,611,204, the disclosure of which is incorporated herein by reference.

The interconnection between the multiple hazard detectors 20 provided by the detector infrastructure allows an alarm signal generated by any one of the hazard detectors 20 to trigger an alarm at all of the other interconnected detectors 20. In the embodiment of the invention shown in FIG. 1, the hazard detectors 20 can be any one of multiple types, such as a smoke alarm, heat alarm, motion detector, carbon monoxide alarm, gas alarm or any combination of these types. Each of the hazard detectors 20 is powered by a line voltage and preferably includes a battery back-up, although it can also function with battery powered detectors.

As shown in FIG. 1, the building 10 includes a hazardous condition detector that includes wireless communication capability, referred to hereinafter as a combination detector 24. The combination detector 24 includes both a hazardous condition detection circuit 26 and a wireless communication device 28 contained within a unitary housing 30, as best shown in FIG. 3. As illustrated in FIG. 1, the combination detector 24 is preferably mounted to the ceiling 30 within a central room of the building. Mounting the combination detector 24 to the ceiling 30 within a central room of the building enhances and optimizes the transmission range for the wireless communication device 28. The combination detector 24 could also be mounted to a wall within a central room as long as the mounting position meets the relevant code requirements for the detector.

In the preferred embodiment of the invention, as illustrated in FIG. 3, the wireless communication device 28 is a wireless repeater that receives wireless network communication signals 32 and retransmits the wireless network communication signals 33. As an example, the wireless communication device 28 can be configured to receive the wireless network communication signals from the wireless router 18 and retransmit the communication signals to the peripheral device of the user 14. Likewise, communication signals from the peripheral device are received by the wireless repeater and are retransmitted to the router 18. As can be understood in FIG. 1, the selective positioning of the combination detector 24 within the building 10 will greatly enhance and expand the connectivity range of the wireless network as compared to a network including only the wireless router 18.

The wireless communication device that is included in the combination detector 24 shown in FIG. 1 is a conventional wireless repeater that can be used with a WI-FI wireless communication network. Alternatively, the wireless communication device could be other types of repeaters to communicate using various different types of wireless communication systems, such as but not limited to WI-FI (IEEE 802.11 and all variants), Zigbee (IEEE 802.15.4) and Bluetooth (IEEE 802.15.1) solutions, as well as other line-of-sight technologies such as IR. Further, the wireless communication device can be configured to communication at various speeds (22 Mbps, 54 Mbps) depending upon the specific type of application.

In the embodiment of the invention illustrated in FIG. 1, only a single combination detector 24 is shown utilized within the building 10. In the embodiment illustrated, the combination detector 24 forms part of the wireless connectivity infrastructure within the building 10 and provides an intermediate communication step between the peripheral device and the wireless router 18.

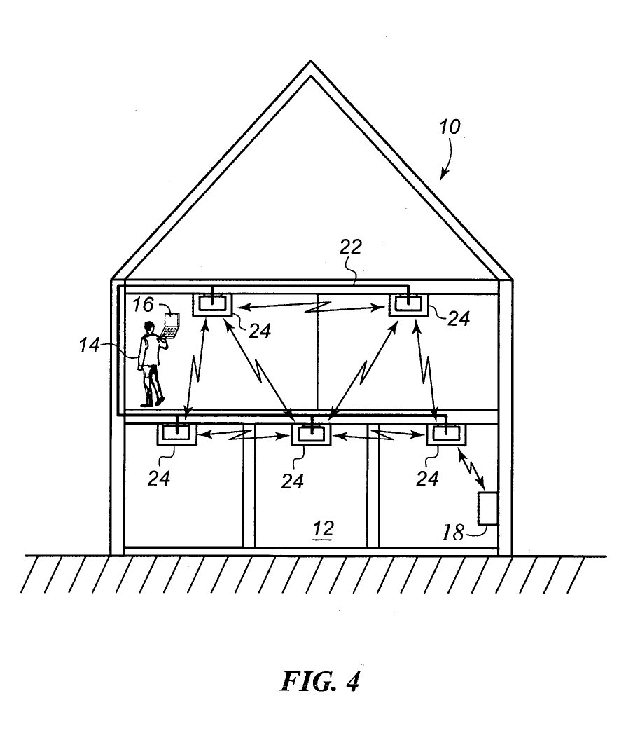

Referring now to FIG. 4, thereshown is an alternate embodiment in which a combination detector 24 is positioned in each of the rooms within the building 10. In the embodiment illustrated, each of the combination detectors 24 can communicate with at least one other combination detector 24 to define a cellular-type network within the building 10. In the embodiment illustrated, the router 18 can be configured to have only a relatively limited range, since the router 18 only needs to communicate with the combination detector 24 mounted within the same room 12.

The combination detectors 24 each communicate with each other such that if a user 14 is within any of the rooms of the building 10, the peripheral device, such as laptop computer 16, can communicate with at least one of the combination detectors 24. The wireless communication device contained within each of the combination detectors 24 can then also be selected to have only a relatively limited range, since each wireless communication device only needs to receive and transmit communication signals to one of the other combination detectors 24. One significant advantage of the embodiment shown in FIG. 4 is enhanced security, since each of the wireless communication devices has a relatively limited range. Thus, the connectivity range of the wireless network would cover the entire building, but would not extend much past the boundaries of the building 10.

In the embodiment of the invention illustrated in FIG. 4, the wireless communication between each of the combination detectors 24 could be any one of the wireless systems previously described, such as WI-FI, Zigbee, Bluetooth or IR. In the embodiment illustrated, both Bluetooth and IR would be particularly desirable due to the relatively limited transmission range of both of these types of wireless communication systems. As can be understood in FIG. 4, the plurality of combination detectors 24 positioned throughout the various rooms within the building 10 creates a wireless infrastructure that enhances the wireless connectivity throughout the entire building 10.

As illustrated in FIG. 1, the combination detector 24 is configured to receive electrical power from the hazard detector infrastructure already in place for the interconnection of the hazard detectors 20. Thus, the wireless communication device that is formed as part of the combination detector 24 can received electrical power without any additional power connections required within the building 10. Further, since the hazard detectors 20 are typically mounted to a ceiling of the building 10, the replacement of one of the hazard detectors 20 by the combination detector 24 places the wireless communication device in a optimal position for enhancing the connectivity range of the wireless network within the building 10. Although only a single combination detector 24 is shown in the embodiment of FIG. 1, it is contemplated that multiple combination detectors 24 could be utilized depending upon the overall size of the building 10 including the wireless network.

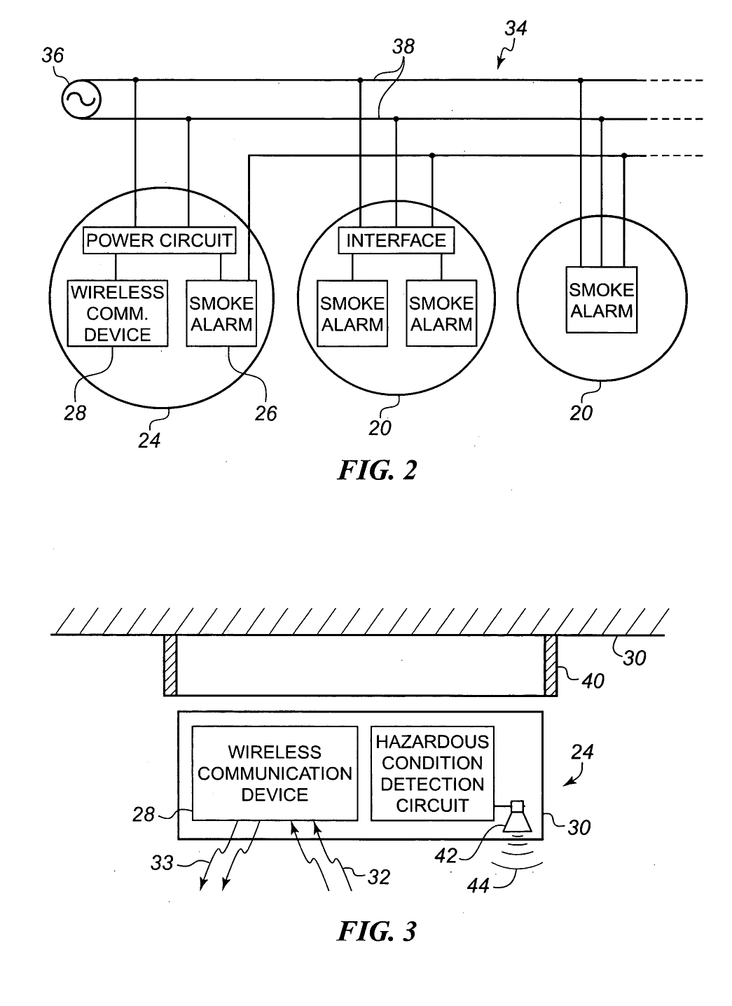

Referring now to FIG. 2, thereshow is the detailed connection between the standard hazard detector 20, the combination detector 24 and the hazard detector infrastructure 34 within the building. As illustrated in FIG. 2, the infrastructure 34 includes a power supply 36 that feeds two of the interconnect lines 38. The external power supply 36 is typically an alternating current (AC) source at a nominal 115 VAC and 60 Hz frequencies. If the combination detector 24 is used with a security system, the power lines would typically supply twenty four volts, which would be sufficient to provide operation power for the wireless communication device.

As illustrated, each of the conventional hazardous condition detectors 20 receives a supply of power from the interconnect lines 38 to power the operating circuits within each of the detectors 20. In the embodiment illustrated in FIG. 2, one of the conventional hazard detectors 20 is a legacy smoke alarm, while the other detector is a detector that generates an alarm signal upon detection of either smoke or carbon monoxide. Although these two types of detectors 20 are shown in FIG. 2, it should be understood that various other types of hazard detectors 20 could be utilized within the system of the present invention.

The combination detector 24 includes the wireless communication device 28 and the hazardous condition detection circuit 26. In the embodiment of the invention shown in FIG. 2, the hazardous condition detection circuit 26 is shown as a smoke detection circuit. However, it should be noted that the detection circuit 26 could be for detecting any type of hazardous or monitored condition, such as smoke, carbon monoxide, heat, movement or other similar condition.

As illustrated in FIG. 2, the wireless communication device 28 draws electrical power from the pair of interconnect lines 38 coupled to the external power supply 36. Since the hazard detector infrastructure 34 is already present in the building, the power supply for the wireless communication device 28 does not need to be added to the building. Instead, one of the conventional hazard detectors 20 can simply be removed and replaced with the combination detector 24. The combination detector 24 is configured with power connect pins that provide electrical power to both the hazardous condition detector circuit 26 and the wireless communication device 28.

Referring now to FIG. 3, the combination detector 24 is configured to have a unitary housing 30 that includes and encompasses both the hazardous condition detection circuit 26 and the wireless communication device 28. Preferably, the unitary housing 30 is designed to have the same overall size and general configuration as a conventional hazard detector 20 utilized within the building 10. As illustrated in FIG. 3, a mounting bracket 40 is typically already mounted to the ceiling 30 and provides a mounting platform for the combination detector 24. Since the mounting bracket 40 may be already in place within the building, the housing 30 for the combination detector 24 is configured to be received within the mounting bracket 40. In this manner, a conventional hazard detector 20 can simply be removed and replaced by the combination detector 24 including the wireless communication device 28.

As illustrated in FIG. 3, the hazardous condition detector circuit 26 is coupled to a conventional horn 42 that can be actuated by the hazardous condition detection circuit 26 to generate an audible alarm signal 44. The generation of the audible alarm signal 44 and conventional horn 42 is well known and provides adequate warning within the building of the detection of a hazardous condition.

Various alternatives and embodiments are contemplated as being within the scope of the following claims particularly pointing out and distinctly claiming the subject matter regarded as the invention.

1. A combined condition detector and wireless network infrastructure device, comprising:
a housing;
a condition detection circuit contained within the housing and operable to generate an alarm signal upon detection of a predetermined condition; and
a wireless communication device contained within the housing, the wireless communication device operable to receive wireless network communication signals and transmit the wireless network communication signals.

2. The combined detector of claim 1 wherein the housing is configured to mount to a mounting bracket of a condition detector.

3. The combined detector of claim 1 wherein the condition detection circuit detects a hazardous condition and generates an audible alarm signal upon detection of the hazardous condition.

4. The combined detector of claim 1 wherein the wireless communication device is a wireless repeater operable to receive wireless network communication signals and retransmit the wireless network communication signals.

5. The combined detector of claim 4 wherein the wireless repeater receives a WI-FI network communication signals and retransmits the WI-FI network communication signals.

6. The combined detector of claim 3 wherein the hazardous condition detection circuit is operable to detect the presence of smoke.

7. The combined detector of claim 3 wherein the hazardous condition detection circuit is operable to detect both smoke and carbon monoxide.

8. The combined detector of claim 1 wherein the condition detection circuit detects movement.

9. A combined hazardous condition detection and wireless connectivity system for use within a building having a detector infrastructure, the system comprising:
a wireless network router positioned within the building and operable to transmit and receive wireless communication signals; and
at least one combined hazardous condition detector and wireless repeater positioned within the building to receive the wireless communication signals from the wireless router and retransmit the wireless communication signals for receipt by a peripheral device within the building,
wherein the combined hazardous condition detector and wireless repeater includes a hazardous condition detection circuit operable to generate an alarm signal upon the detection of a hazardous condition.

10. The system of claim 9 wherein the wireless repeater and the hazardous condition detection circuit are contained within a unitary housing.

11. The system of claim 10 wherein the housing is configured for mounting to a mounting bracket of a hazard detector.

12. The system of claim 10 wherein the hazardous condition detection circuit and the wireless repeater are coupled to a line voltage of the detector infrastructure.

13. The system of claim 9 wherein the detector infrastructure includes at least one hazard detector in conductive communication with the combined hazardous condition detector and wireless repeater, the hazard detector being operable to generate an alarm signal upon detection of the hazardous condition.

14. The system of claim 9 wherein the wireless communication signals are WI-FI signals.

15. The system of claim 9 wherein the hazardous condition detector circuit generates the alarm signal upon detection of smoke.

16. The system of claim 9 wherein the hazardous condition detector circuit generates the alarm signal upon detection of smoke or carbon monoxide.

17. A combined hazardous condition detector and wireless network infrastructure device for use in a building having a plurality of hazard detectors interconnected by a detector infrastructure, the combined detector comprising:
a housing;
a hazardous condition detection circuit contained within the housing and operable to generate an alarm signal upon detection of a hazardous condition; and
a wireless repeater contained within the housing, the wireless repeater being operable to receive wireless network communication signals and retransmit the wireless network communication signals,
wherein both the hazardous condition detection circuit and the wireless communication device are connected to the detector infrastructure.

18. The combined detector of claim 17 wherein the hazardous condition detection circuit and the wireless repeater are coupled to a line voltage of the detector infrastructure.

19. The combined detector of claim 18 wherein the combined hazardous condition detector and wireless repeater is in conductive communication with at least one hazard detector through the detector infrastructure.

20. The combined detector of claim 17 wherein the housing is configured to be received by a mounting bracket of one of the hazard detectors.

21. A wireless computer network infrastructure device, comprising:
a housing;
a wireless repeater contained within the housing, the wireless repeater being operable to receive wireless computer network communication signals and retransmit the wireless computer network communication signals; and
a condition detection circuit contained within the housing and operable to generate an alarm signal upon the detection of a predetermined condition.

22. The infrastructure device of claim 21 wherein the wireless computer network communication signals are transmitted using WI-FI.

23. The infrastructure device of claim 21 wherein the wireless computer network communication signals are transmitted using Bluetooth.

24. The infrastructure device of claim 21 wherein the condition detection circuit detects a hazardous condition and generates an audible alarm upon the detection of the hazardous condition.

25. The infrastructure device of claim 21 wherein the condition detection circuit detects a security condition and generates an alarm indication signal upon the detection of the security condition.
